(19) United States
(12) Patent Application Publication
(10) Pub. No.: US 2013/0230150 A1
(43) Pub. Date: Sep. 5, 2013

(54) MEASUREMENT ARRANGEMENT FOR A COMPUTED TOMOGRAPHY SCANNER

(71) Applicant: Daniel Weiss, Essingen-Forst (DE)

(72) Inventor: Daniel Weiss, Essingen-Forst (DE)

(73) Assignee: CARL ZEISS INDUSTRIELLE MESSTECHNIK GMBH, OBERKOCHEN (DE)

(21) Appl. No.: 13/884,759

(22) PCT Filed: Oct. 18, 2011
(86) PCT No.: PCT/EP2011/068201

§ 371 Date: May 10, 2013

(30) Foreign Application Priority Data
Nov. 10, 2010 (DE) 10 2010 050 949.3

(51) Int. Cl. G01T 7/00

(52) U.S. Cl. CPC G01T 7/005
USPC 378/207

(57) ABSTRACT

A method for operating a measurement arrangement for a computer tomograph. The measurement arrangement has a radiation source of invasive radiation and a flat image detector with scintillation layer and a photocell array of photocells for detection of radiation from the radiation source. A calibration object is arranged between the radiation source and the flat image detector, and at least one radiation image of the calibration object is recorded with the flat image detector. From known dimensions of the calibration object and from the at least one radiation image, a distortion error, which occurred as a result of a distortion of the flat image detector, is determined as a function of the location in the photocell array (device 6). In particular, a radiation image of an object to be measured, recorded with the flat image detector, is corrected on the basis of the determined distortion error.

The invention relates to a method for operating a measurement arrangement for a computed tomography scanner, wherein the measurement arrangement comprises a radiation source of invasive radiation and a flat-panel image detector. The invention furthermore also relates to such a measurement arrangement. The invention relates to the field of image generation, in particular for measuring or determining coordinates of a measurement object, using a radiation source, which generates invasive radiation, i.e. radiation (e.g. X-ray radiation or particle radiation) which penetrates a measurement object, is attenuated in the process by absorption and/or scattering and impinges on an image generation apparatus.

Furthermore, the invention relates to the field of computed tomography scanners, in particular such computed tomography scanners in which a conical radiation beam propagates from the radiation source (e.g. a microfocus X-ray tube) to the image generation apparatus through the measurement object. In order to measure the measurement object, such radiation beams are successively radiated through the measurement object from different directions, usually by virtue of the measurement object being rotated about an axis of rotation. From this, the computed tomography scanner calculates a three-dimensional image of the measurement object by means of so-called reconstruction (e.g. filtered back projection).

Radiographs, which are the result of irradiating a measurement object with invasive radiation, used to be made visible with the aid of a so-called image amplifier. Here, the radiation to be detected impinges onto a combination of a scintillator and a photocathode, which generates photoelectrons which are imaged on a screen or a field made of photocells by means of an electric field. As a result of converting the impinging radiation initially into visible light and then into photoelectrons, there is scattering, which impairs the sharpness and resolution of the images. It is also possible to observe distortion, i.e. a systematic deviation of the location in the generated image from the location which would have been reached along a straight path from the radiation source to the screen. Here, the strength of the distortion generally varies significantly with the location on the screen or photocell field such that, depending on the relative position of the measurement object with respect to the detector arrangement, different dimensions of the measurement object emerge in the radiograph. It is therefore conventional to calibrate the detector arrangement and to correct the distortion.

By contrast, in accordance with the present invention, the invasive radiation impinges on a flat-panel image detector after passing through the measurement object. The flat-panel image detector has a scintillation layer, particularly in a fashion known per se, which is preferably carried by a photocell field made of photocells for detecting the radiation. At the very least, the scintillation layer is directly adjacent to the photocell field, which is also indicated by the designation flat-panel image detector, and preferably also adjoins the photocell field.

In contrast to the image amplifiers specified above, the path which the light photons, generated by the scintillator material (e.g. cesium iodide), travel to the associated photocell is very short and preferably only extends through the scintillator material and the adjoining photocell material. In the case of the flat-panel image detector, the scintillation layer can, for example, consist of a multiplicity of scintillator bodies (e.g. needle-like bodies). In this case, many such scintillator bodies are arranged on each photocell, the diameters of which scintillator bodies are respectively 5 to 10 μm in directions across the radiation direction. By contrast, the edge length of the associated photocell, and hence the pixel dimension of the generated image, is e.g. 100 to 150 μm. Such flat-panel image detectors are generally considered to be free from distortion errors.

However, trials evaluated by the inventor have shown that a distortion occurs even in the case of a measurement arrangement with a flat-panel image detector of the type described above, in which distortion the location in the recorded radiograph deviates from the location expected in the case of radiation propagation and radiation detection along a straight line, wherein the strength of the distortion depends on the location in the recorded radiograph. In the evaluated case, the strength of distortion lies at up to 20 μm and varies over the surface of the image detector in such a way that leads to variations of measured lengths in the measurement object, which can be up to 5 μm; i.e., depending on the relative positions of the measurement object and the image detector, the measurement length can vary by up to 5 μm.

It is an object of the present invention to operate a measurement arrangement of the type mentioned at the outset in such a way as to achieve measurement results which are as accurate as possible, particularly when determining coordinates of a measurement object and dimensions of a measurement object. It is a further object of the present invention to specify a corresponding measurement arrangement.

First of all, the invention is based on the discovery that although the observed distortion is significantly smaller than the usual edge length of a pixel of the flat-panel image detector (the edge length is typically 100 to 150 μm, but can also be up to 400 μm), it is nevertheless important, particularly in cone beam computed tomography, to avoid errors in the sub-pixel range. In particular, the various radiographs recorded for the reconstruction together contribute to the three-dimensional image which is calculated by the computed tomography scanner. By way of example, the individual radiographs contain information in respect of the profile of external surfaces and material boundaries of the measurement object, which is an object, produced manually or industrially, in the preferred field of application of the invention. Although an individual point of the measurement object cannot be localized with a resolution in the sub-pixel range, this is possible, for example, by means of local interpolation or compensation calculations for structures of the measurement object. A systematic error as a result of distortion therefore already has an effect in the case of possible pre-processing of individual radiographs (e.g. in order to establish structures by means of the aforementioned interpolation or compensation calculation) and, in particular, has an overall effect on the three-dimensional image, which is calculated from the individual radiographs by reconstruction. In particular, the aforementioned interpolation or compensation calculation can also be carried out on the basis of the three-dimensional image.

The fact that the strength of the distortion lies in the sub-pixel range is a possible reason for the distortion not having been discovered previously, especially since other systematic errors also occur in measurement arrangements of computed tomography scanners, e.g. as a result of the effect of the so-called beam hardening, as a result of artifacts in the reconstruction (e.g. so-called Feldkamp artifacts) and misalignments of the axis of rotation about which the measurement object is rotated in order to obtain radiographs in the case of different radiation directions. In fact, the inventor could only determine the effect of distortion after all other possible causes had been excluded. The geometric distortion could only be established by analyzing a plurality of three-dimensional overall images, which image the same measurement object in various relative positions with respect to the detector. In particular, this required a measurement object with precisely known dimensions, e.g. a measurement object with a plurality of characteristic structures, the relative positions of which are known (in particular an arrangement with a plurality of spheres, the sphere centers of which lie at known locations).

There are various possible reasons for the distortion at the sub-pixel level. A possible reason is a mechanical distortion of the flat-panel image detector. It is also possible that the internal structure of the scintillator material is responsible for the distortion. Furthermore, a mechanical tension caused by the scintillator structures could be the reason for the distortion. A combination of the aforementioned possible causes could also be the reason for the distortion.

It is now proposed to establish the distortion as a function of the location in the photocell field of the flat-panel image detector. To this end, use is made of a calibration object with known dimensions.

In particular, the following is proposed: a method for operating a measurement arrangement for a computed tomography scanner, said measurement arrangement comprising a radiation source of invasive radiation and a flat-panel image detector with a scintillation layer and a photocell field made of photocells for detecting radiation from the radiation source, wherein a calibration object is arranged between the radiation source and the flat-panel image detector and at least one radiograph of the calibration object is recorded using the flat-panel image detector and a distortion error, which was created as a result of a distortion of the flat-panel image detector, is established as a function of the location in the photocell field from known dimensions of the calibration object and from the at least one radiograph. A radiograph of an object to be measured is preferably recorded by the flat-panel image detector and corrected, taking into account the established distortion error.

The calibration object is preferably arranged directly adjoining the flat-panel image detector. In particular, the calibration object can be arranged in such a way that structures of the calibration object extend along the flat-panel image detector and, in the at least one radiograph of the calibration object generated by the flat-panel image detector, appear as structure images lying next to one another and/or partly overlapping one another.

Here, the calibration object can preferably have an arrangement with a multiplicity of separate structures, the size of which and the position of which relative to one another is known. The size and the relative position are used when establishing the distortion error. The use of a plurality of structures which generate structure images distributed over the surface of the photocell field renders it possible to determine the distortion at least at a corresponding number of positions of the photocell field.

Moreover, the assumption can be made that the strength of the distortion does not vary discontinuously over the extent of the surface of the photocell field, but rather varies continuously. Therefore it is possible to determine the distortion not only at positions of the photocell field at which structure images were recorded, but also at positions which lie between the recorded structure images. Here, an interpolation, for example, can be carried out, for example by linear interpolation, or a model function can be adapted by a compensation calculation. As a result, e.g., a two-dimensional map of the distortion is obtained, wherein each location on the map corresponds to a location in the photocell field and hence to an image location. A value of the distortion error preferably exists at least for each photocell of the field and hence for each pixel of a radiograph. The distortion error is a two-dimensional vector and consists of an x-component and a y-component. In particular, the calibration object can be arranged in various positions and/or alignments relative to the flat-panel image detector and at least one radiograph can in each case be recorded and evaluated. The distortion error can be established with a higher resolution from the radiographs of the various relative positions and relative alignments. In particular, as a result of this, a greater number of nodes are obtained for the interpolation or compensation calculation, by means of which the distortion error can be determined for arbitrary locations of the photocell field.

In particular, a calibration object with a plurality of structures is also understood to mean an arrangement of a plurality of objects, the relative position of which is fixed. An arrangement with a plurality of objects, which are at a distance from one another and which have a first attenuation coefficient, is preferred. The attenuation coefficient is the material coefficient which describes the attenuation of the invasive radiation passing through the material. As mentioned above, the objects are at a distance from one another, wherein the space therebetween can be wholly or partly filled by material which has a different attenuation coefficient. By way of example, the first attenuation coefficient (the coefficient of the objects) can be very large, and so the radiation passing through the objects is absorbed and/or scattered in other directions than in the direction of the photocell field to a very high percentage. By way of example, the objects are steel spheres. By contrast, it is preferred if the material (e.g. glass) in the spaces in between the objects has an attenuation coefficient which differs significantly from the attenuation coefficient of the material of the objects. Glass ceramic is very suitable since the shape thereof remains stable over a long time and in the case of temperature changes. As a result, a projection image with alternating dark and light areas, wherein the external edges of the dark areas correspond to the external contours of the objects with a high attenuation coefficient, is obtained as an image of the whole arrangement of objects.

In a specific embodiment of such an arrangement, the objects can be spheres, which are preferably distributed in accordance with a regular grid in rows and columns with respectively the same distances between the spheres. Here, preferably both the row direction and the column direction extend parallel to the surface of the photocell field. The projection images of spheres, which are produced by a conically divergent radiation beam, are ellipses in the general case and circles, which in turn are a specific case of ellipses, only in special cases. From the outer contours of the corresponding structure images (i.e. the ellipses), it is possible to determine the center of the ellipse in a simple fashion. Within the scope of this description, the term “ellipse” is therefore not understood to mean the contour line, but rather the area with an elliptical contour line.

On the other hand, spheres renders it possible in a simple way, for example by means of a coordinate measurement instrument which touches the spheres in a tactile fashion, i.e. by touching the surface, to determine the relative positions of the spheres in the sphere arrangement. In particular, this renders it possible to determine the positions of the sphere centers of the arrangement in a coordinate system which is associated with the arrangement. This determination can be carried out with an accuracy of better than one micrometer. Additionally, it is possible for spheres to be produced with a very low circular error, i.e. the sphere surface lies at a constant distance from the sphere center with a high accuracy. After a correction based on the fact that the projected sphere center does not coincide with the center of the ellipse, it is therefore possible to carry out a comparison which results in the distortion error with high precision.

A coordinate measurement instrument is preferably used not only for the separate measurement of such an arrangement of calibration spheres but also for possible other calibration objects, which coordinate measurement instrument touches the surface of objects in the arrangement in order to establish therefrom the required information in respect of the shape, relative position and arrangement of the objects. However, other methods for obtaining the coordinates of the calibration arrangement are also possible. By way of example, use can also be made of a coordinate measurement instrument with an optically scanning sensor.

A different type of objects can also be assembled instead of spheres in order to form a calibration arrangement. It is also possible to assemble different types of objects to form a calibration arrangement. In addition to spheres, cylinders, hollow cylinders, circular disks and/or checkerboard-like structures for example are also suitable. In the case of checkerboard-like structures, regions with high and low attenuation coefficients alternate in accordance with the arrangement of white and black fields on a checkerboard. In the radiograph of the checkerboard, the locations at which four fields meet can be determined robustly and with sub-pixel accuracy. In particular, it is also possible for the number, the material and/or the size of the utilized objects to be varied in the various calibration arrangements, as can be the relative arrangement and possibly the relative alignment thereof.

In particular, the objects of the calibration arrangement need not, as in the case of spheres, have a spatial extent in the direction of the propagation direction of the invasive radiation which are of the same order as the width and height of the objects, extending transversely to the radiation propagation direction. Rather, a suitable calibration arrangement can be an arrangement with a plurality of flat objects. By way of example, such calibration objects can consist of a material layer, which is arranged on the surface of a carrier material. Here, the material of the material layer and the material of the carrier have different attenuation coefficients for the invasive radiation. In particular, the material layer is structured in such a way in this case that this results in the individual objects of the arrangement. A suitable carrier for such a structured material layer is, in particular, a plate-shaped carrier. Such a plate-shaped carrier with a planar surface on which the structured material layer is applied can be arranged very tightly against the flat-panel image detector. Such an arrangement, in which the structured material layer is arranged on the side of the plate-shaped carrier which faces the flat-panel image detector, is preferred. By way of example, the structured material layer can in this case touch the surface of the flat-panel image detector or—if touch could damage the structured material layer—provision is made in a more preferred fashion for a small distance of at least one hundredth of a millimeter and at most one millimeter between the structured material layer and the surface of the flat-panel image detector.

A structured material layer as calibration arrangement is preferably produced on a plate-shaped carrier in a similar fashion as in production methods for producing structured semiconductor components for microelectronic components by carrying out at least one lithographic process. By using at least one mask, which in each case corresponds to at least one part of the external contours of an object, and by using radiation which images the shape of the respective mask onto the surface of the carrier material, the structures of the structured material layer are defined. A suitable material for the structured material layer is e.g. chromium, which can be applied onto a plate-shaped carrier made of glass or glass ceramic. By way of example, crosses made of the material are suitable structures. The center of the cross or the center of the projection of the cross can be determined for each cross in an analogous fashion to determining the projected sphere center in the case of the aforementioned spherical calibration object. All other steps, which are described in this description in respect of an arrangement of spheres for determining the distortion error, can also be carried out in an analogous fashion in the case of a calibration object with a plurality of crosses.

A preferred exemplary embodiment for a cross as calibration object and for a calibration arrangement with a plurality of crosses, which are arranged adjoining a flat-panel image detector, will still be described in the description of the figures.

In particular, the calibration object or the calibration arrangement can be attached to a movement apparatus, which is arranged and embodied in such a way that the movement apparatus can move the calibration object relative to the flat-panel image detector. This is how the calibration object can be brought into various relative positions with respect to the flat-panel image detector.

The scope of the invention optionally also includes the correction of the error caused by the distortion in at least one radiograph of a measurement object. Therefore the distortion is corrected by carrying out the correction.

When correcting a radiograph which was recorded of a measurement object to be measured, it is possible, in particular, to correct the whole radiograph in accordance with the distortion error, e.g. each pixel of the radiograph.

However, during the correction it is not mandatory for the whole radiograph to be corrected in accordance with the distortion error. By way of example, there are applications in which only individual points are to be identified in the radiograph of a measurement object. In this case, it is preferred only to correct the individual points in accordance with the distortion error. By way of example, a measurement object with an arrangement of a plurality of spheres can be employed not only as calibration object for determining the distortion error, but also for setting the whole measurement arrangement.

In particular (as described in DE 10 2005 033 187 A1), it is possible to record at least one radiograph of a calibration object during the calibration of a measurement arrangement, e.g. a computed tomography (CT) measurement arrangement, which generates images of measurement objects by means of invasive radiation. By way of example, this measurement arrangement can be the same measurement arrangement and, optionally, also the same calibration object by means of which the distortion error of the flat-panel image detector is established. The calibration object has known dimensions, wherein geometry parameters of a geometric model which describes a geometry of the measurement arrangement are determined by evaluating the at least one radiograph. In a preferred embodiment of the method, the calibration object comprises at least one calibration element with a spherical surface (sphere surface) and/or a calibration element, the surface of which forms at least part of a sphere surface. The calibration element is imaged as an ellipse in the radiograph and the center of the sphere projection is determined by virtue of establishing the ellipse center from the radiograph and optionally also correcting a deviation of the position of the projected sphere center as a result of the projection (e.g. as is the case below in the description of the figures). Geometric information in respect of the center in the radiograph, i.e., for example, the position, the relative position and/or the distance are then used when determining the geometry parameters of the model. According to the invention, the center is a point which was obtained by correcting the distortion error. In order to determine the geometry parameters, it is therefore only necessary for individual points, in this case centers, to be determined and corrected, and not the whole radiograph.

Worded more generally, the flat-panel image detector can record at least one radiograph of the calibration object or another measurement object, individual points can be established in the radiograph, which points respectively correspond to a structure of the calibration object or measurement object, and the distortion error can be corrected only with respect to these individual points such that an arrangement of corrected individual points is formed.

The flat-panel image detector, the calibration object or measurement object and a radiation source of the invasive radiation are part of the measurement arrangement. In particular, the arrangement of corrected individual points can then be used to determine geometry parameters of a geometric model which describes a geometry of the measurement arrangement.

Preferably, as already described, a map of the distortion errors is established in the calibration. This is also understood to mean that the information in respect of the distortion error and/or the correction of the distortion error to be correspondingly carried out is available for each location of the photocell field. The information in respect of the distortion error can, for example, be available in the form of a vector, i.e. a length and a direction. Here, the vector points from the respective location in the radiograph to the location which the image point would have assumed without the effect of the distortion. However, in order to carry out the correction, the inverse distortion error vector is also advantageous, i.e. a vector of the same length and opposite orientation, which points from the location of a pixel of an image to be obtained by correction to that point in the radiograph whose associated image value is to be assumed in the corrected image. Here, the inverse distortion error vector can generally point to a point in the coordinate system of the recorded radiograph which lies between known image points (each image point corresponds to e.g. one pixel). The image value (e.g. grayscale value), which is assumed in the corrected image, is then preferably established by interpolation from the neighboring image points in the radiograph. In the case of a bilinear interpolation, the closest neighboring image points are used in each case for the interpolation in both coordinate directions of the coordinate system of the radiograph. In the case of a bi-cubic interpolation, image points which are not directly neighboring are also included in the interpolation, i.e. surroundings with 4×4 image points. In any case, an image value weighted in accordance with the distance of the location from the neighboring image points is established by interpolation. The interpolation method takes account of the fact that the distortion error lies in the sub-pixel range.

Worded more generally, a location corresponding to the distortion error is established in a recorded radiograph for correcting the distortion error for an image point of the corrected image and the associated image value (e.g. grayscale value) of the location is established by interpolating the image values of neighboring nodes in the radiograph. In particular, the nodes are the locations of the pixels, assumed to be punctiform, of the radiograph (e.g. the center of the respective pixel).

The establishment of the distortion, in particular the establishment of the aforementioned distortion map, and/or the correction of the distortion can in particular be executed by a computer which works through a corresponding computer program. The scope of the invention therefore includes a computer program which comprises steps that can be executed by computer, by means of which steps image data which correspond to at least one radiograph and information in respect of structures of a calibration object, which are imaged in the at least one radiograph, can be used to establish the distortion error in a way as described in this description.

The scope of the invention furthermore includes a computer program which comprises steps that can be executed by computer, by means of which steps the image data of at least one radiograph are corrected in respect of the distortion error in a way as described in this description.

Moreover, the scope of the invention also includes a measurement arrangement for a computed tomography scanner, comprising a radiation source of invasive radiation and a flat-panel image detector with a scintillation layer and a photocell field made of photocells for detecting radiation from the radiation source. The measurement arrangement moreover comprises an error establishment apparatus, which is connected to the flat-panel image detector and designed to establish a distortion error from at least one radiograph of the calibration object, which is arranged between the radiation source and the flat-panel image detector, and from known dimensions of the calibration object, which distortion error was created as a result of a distortion of the flat-panel image detector, wherein the distortion error is established as a function of the location in the photocell field.

Embodiments of the measurement arrangement emerge from the description of the method and the embodiments thereof. In particular, the measurement arrangement can moreover comprise an error correction apparatus, which is connected to the error establishment apparatus and designed to correct a radiograph recorded of an object to be measured, taking into account the distortion error established by the error establishment apparatus.

Furthermore, the measurement arrangement can also comprise the calibration object and/or a tactile coordinate measurement instrument, which is designed to touch the calibration object and to determine the size and position of structures of the calibration object therefrom and to provide these for establishing the distortion error.

The error establishment apparatus can also be embodied to establish at least one location in each case (in particular for each structure) in the radiograph using structure images which were created by the separate structures in the at least one radiograph such that a first arrangement of the established locations is obtained, and to compare the first arrangement to a second arrangement of locations which correspond to the established locations, said second arrangement corresponding to the calibration object, and to establish the distortion error from deviations of the two arrangements as a function of the location in the photocell field and/or in the radiograph. The function can, in particular, be the aforementioned distortion map, e.g. a map of the aforementioned distortion vectors or the aforementioned inverse distortion vectors.

The second arrangement, which corresponds to the calibration object, can be obtained, in particular, by mathematical calculation. Here, the calculation in particular corresponds to a possible projection of the calibration object in the image plane of the radiograph. Therefore, in this embodiment, the first arrangement is obtained inter alia by a projection by means of invasive radiation and the second arrangement is obtained by a calculation of a projection. The calculation incorporates information in respect of the geometry of the calibration object, for example information in respect of the relative position of sphere centers, which, in particular, were obtained by means of the tactile coordinate measurement instrument.

Furthermore, the error establishment apparatus can be designed, for the purposes of comparing the two arrangements, to match the position and orientation of the locations in the second arrangement to the position and orientation of the locations in the first arrangement (in particular, in the best possible manner, e.g. by an optimization algorithm). This serves to take account of different possible relative positions and orientations of the calibration object and the flat-panel image detector. The locations in the second arrangement can be obtained by establishing the best possible second arrangement, e.g. by varying the calculated projection in accordance with different relative positions and orientations of the calibration object and the detector. After the adaptation, remaining deviations of the locations in the first arrangement from corresponding locations in the second arrangement are identified as distortion errors since the remaining deviation can, as a result of the adaptation, no longer be traced back to incorrectly assumed relative positions or orientations of the calibration object and the detector.

Exemplary embodiments of the invention will now be described with reference to the attached drawing. In the individual figures of the drawing:

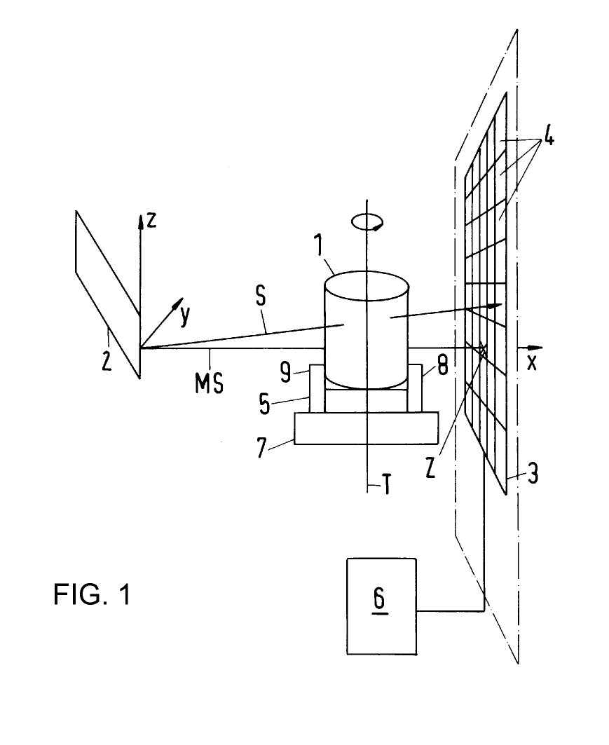

FIG. 1 schematically shows the geometry of a measurement arrangement with an X-ray radiation source, a measurement object and a detector apparatus spatially resolving in two-dimensions,

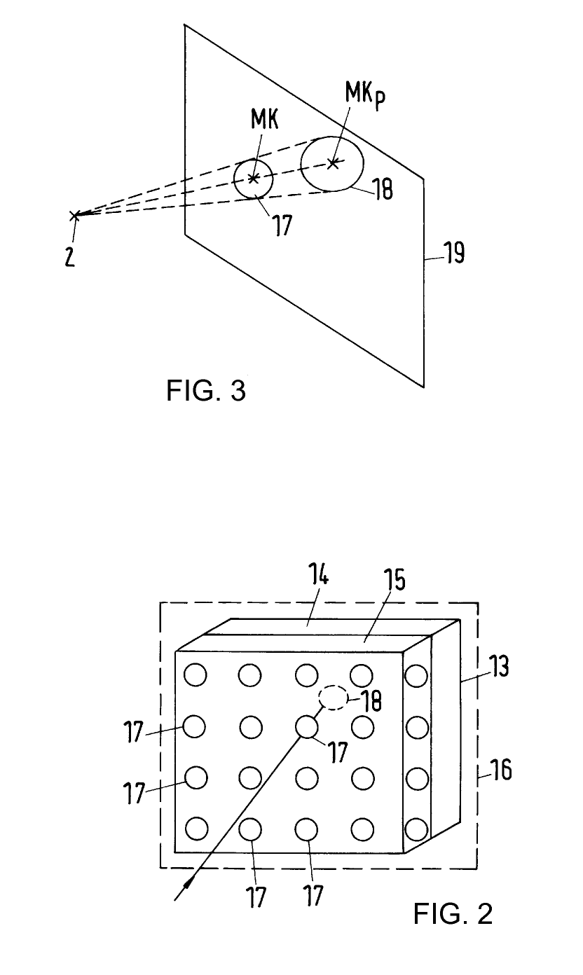

FIG. 2 schematically shows a flat-panel image detector with a scintillation layer and a photocell field behind the scintillation layer, wherein a calibration arrangement is arranged upstream of the scintillation layer in the radiation direction, with a plurality of spheres (e.g. steel spheres) which are arranged in a regular fashion in rows and columns and held by e.g. a glass matrix,

FIG. 3 schematically shows the mapping of a sphere onto an ellipsoidal structure image of the sphere, which is brought about by a conical radiation beam,

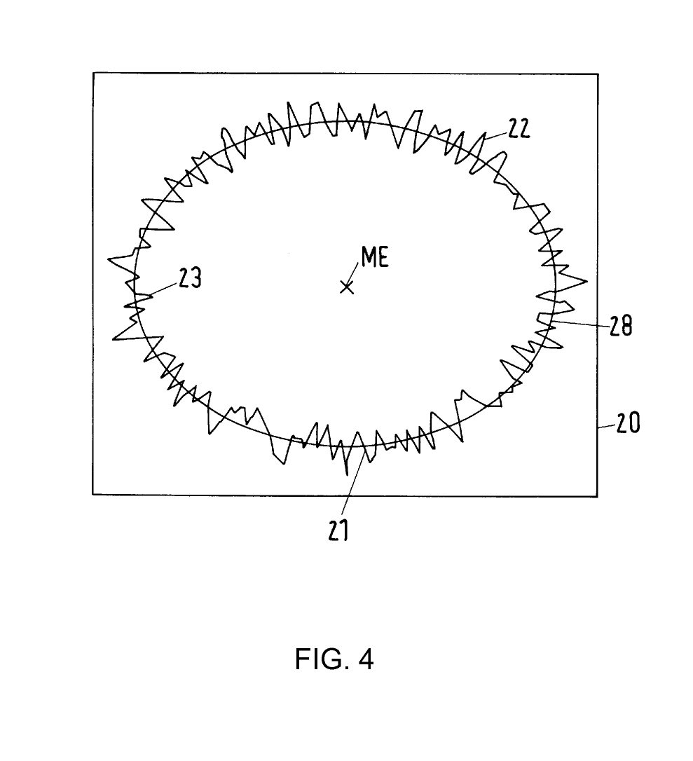

FIG. 4 shows the illustration of a noisy contour obtained from a radiograph section and the compensating ellipse, with illustration of the mean offset,

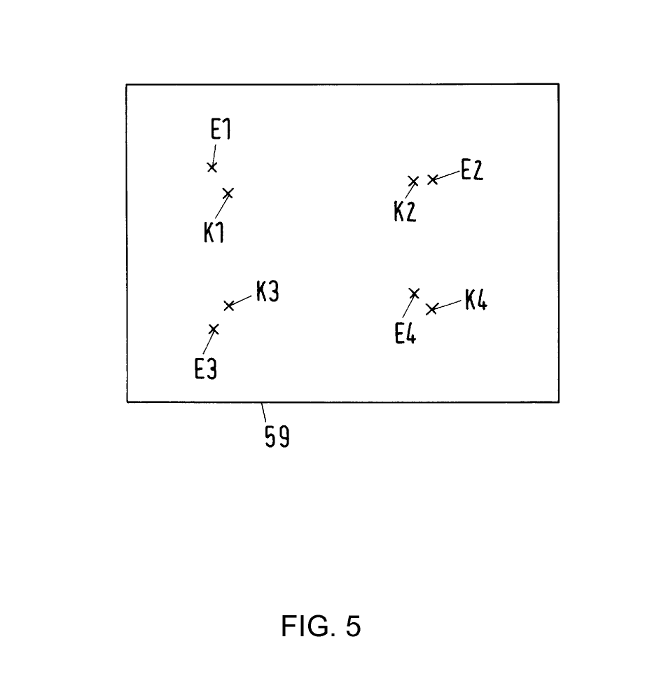

FIG. 5 shows a much simplified example of an arrangement of corrected ellipse centers established from a radiograph, wherein the illustration moreover illustrates a second arrangement of sphere centers adapted in the best possible fashion to the arrangement,

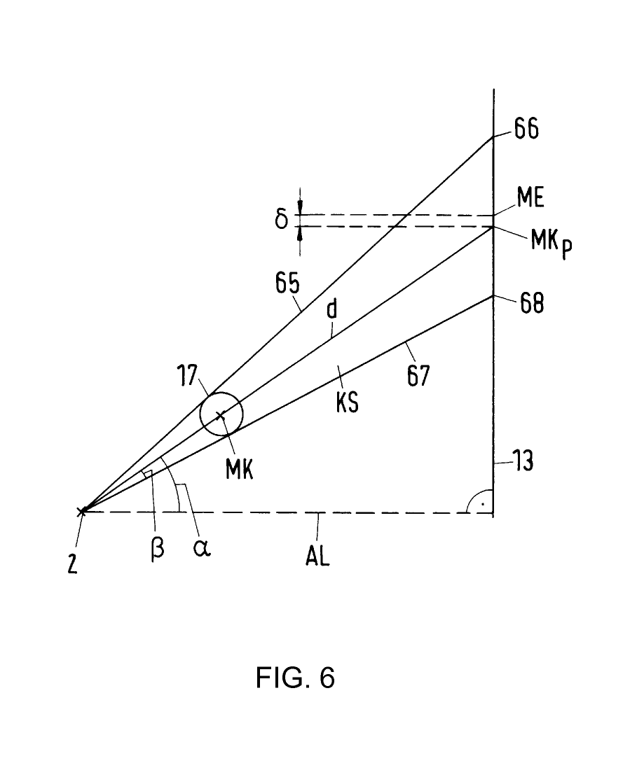

FIG. 6 shows an illustration for explaining that the projected sphere center does not coincide with the center of the ellipse obtained by the projection,

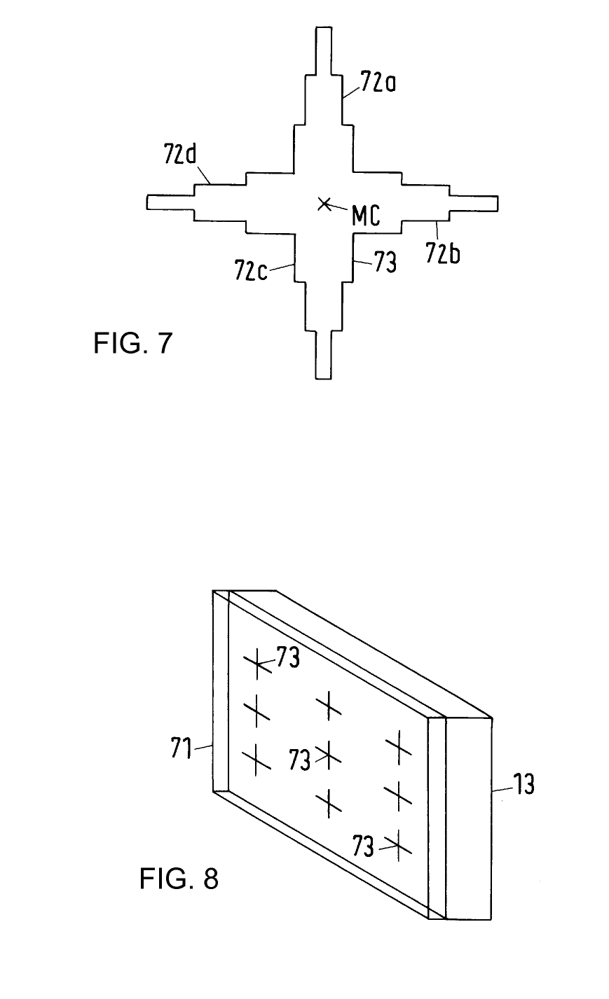

FIG. 7 shows a cross which is formed by a thin material layer and can be applied to a plate-shaped carrier with planar surface and

FIG. 8 shows an arrangement with a plate-shaped carrier, on the rear side of which a plurality of crosses are applied, and with an adjoining flat-panel image detector.

The measurement arrangement illustrated in FIG. 1 comprises a measurement object 1, which is arranged in the straight-lined beam path between a radiation source 2, in particular an X-ray radiation source (e.g. a microfocus X-ray tube), and a detection apparatus 3. A beam is denoted by S, a center beam is denoted by MS. The center beam impinges on the detection apparatus 3 at the point Z. The detection apparatus 3 comprises a multiplicity of detection elements 4 (e.g. photocells with scintillation material lying upstream thereof in the radiation direction), and so a spatially resolved detection of radiation is possible. The detection signals of the detection elements 4 are fed to an apparatus 6, which establishes a radiograph of the measurement object 1, respectively in a given rotational position of the measurement object 1. The measurement object 1 is combined with a rotary apparatus 7, for example a rotary table. The axis of rotation of the rotary apparatus 7 is denoted by T. Moreover, provision is optionally made for a positioning apparatus 5 with holding jaws 8, 9, which renders it possible to position the measurement object 1 relative to the rotary apparatus. By way of example, the apparatus 6 is a computer, which preferably also evaluates digital image data of at least one radiograph from the apparatus 3 and/or processes said image data in order to determine and/or correct the distortion error.

The positioning apparatus 5 is preferably embodied in such a way that it separately enables the positioning of the measurement object 1 in the direction of three coordinate axes x, y, z of a Cartesian coordinate system. Alternatively, or in addition thereto, the positioning apparatus 5 can enable further positioning movements, e.g. rotational movements about an axis of rotation which does not coincide with the axis of rotation T of the rotary apparatus 7. In this manner, the positioning apparatus 5 can also be employed to position a calibration object (not shown in FIG. 1) directly in front of the detection apparatus 3.

FIG. 2 shows a flat-panel image detector 13, which comprises a scintillation layer 15 and a layer 14 arranged therebehind, which is formed by a field of photocells. The layer 14 preferably carries the layer 15, which is not a homogeneous layer but, for example, consists of a multiplicity of needle-shaped scintillation bodies. However, it is possible instead to use a homogeneous layer, e.g. with scintillation material (such as e.g. gadolinium oxide), which, for example, is embedded into a polymer matrix.

FIG. 2 moreover shows a calibration object 16 upstream of the scintillation layer 15 in the radiation direction (a beam of invasive radiation is indicated by an arrow), which calibration object has a regular grid with spheres arranged in rows and columns, of which some have been denoted by reference sign 17. As the beam of invasive radiation indicates, one of the spheres 17 is impinged upon by the beam, the intensity of the beam is attenuated and, as a result, an ellipsoidal image 18 is generated in the photocell field 14 downstream of the scintillation layer 15. In the case of the flat-panel image detector 13 illustrated in FIG. 2, it is, for example, the detector 3 illustrated in the arrangement in accordance with FIG. 1.

FIG. 3 shows a radiation source 2 for invasive radiation (e.g. the radiation source in accordance with FIG. 1), one of the spheres 17 from the arrangement in accordance with FIG. 2 and the elliptical radiation image 18, which is created in an image 19 which is produced by the photocell field 14. Since the center beam, which passes through the center MK of the sphere from the radiation source 2, does not propagate perpendicular to the detection surface of the photocell field, the image 18 is elliptical. The center MK of the sphere projected by the center beam is denoted by the reference sign MKₚ in the elliptical image 18.

FIG. 4 shows a cut-out region 20 of a radiograph, e.g. of the calibration object illustrated in FIG. 2 with a multiplicity of calibration spheres, wherein the region 20 contains a noisy contour line 21 of one of the spheres. It is possible to see that the contour line 21 has a jagged profile with a multiplicity of outwardly directed peaks 22 and with a multiplicity of inwardly directed peaks 23, at which peaks respectively one node is situated. Further nodes are situated between the peaks 22, 23. Each node corresponds to a point established from the radiograph on the edge of the image of the sphere. ME denotes the ellipse center of the ellipse line 28 fitted for example using the compensation calculation. The offset of the nodes from the ellipse line 28 is illustrated in a greatly magnified fashion in the illustration.

The centers of the ellipses of the other sphere images of the calibration arrangement illustrated in FIG. 2 can be determined in the same fashion. Furthermore, in a further step, the overall arrangement of the ellipse centers, which are established from the radiograph and corrected, is compared to the known arrangement of the sphere centers of the calibration object.

In general terms, the calibration object has a multiplicity of separate structures, the size of which and the position of which relative to one another is known, and wherein the size and relative position is used when establishing the distortion error. At least one location in the radiograph is established in each case from structure images, which were created from the separate structures in the radiograph. The arrangement of the determined locations is then compared to an arrangement corresponding to the calibration object.

In the specific example described here (calibration arrangement with a multiplicity of spheres), the arrangement of the sphere centers (in particular by a calculated projection of the calibration arrangement) is, for the purposes of the comparison, introduced into the coordinate system of the established ellipse centers (which form the first arrangement) and adapted in respect of position and alignment by means of a compensation calculation.

However, prior to carrying out the actual comparison of the location determined in the radiograph with the corresponding location of the calibration object, a correction is still optionally carried out, which takes into account the geometric effects of the projection. This optional correction is carried out before executing the compensation calculation. Such a compensation calculation can be executed not only in the case of a calibration arrangement with a multiplicity of spheres but also in the case of other calibration objects which have a plurality of shape features or are composed of a plurality of individual objects. In the case of a sphere, the concept of the correction as a result of geometric effects of the projection is explained below.

FIG. 6 shows, in a two-dimensional illustration, the projection of a sphere 17 with a center MK onto a screen or a detector field 13, e.g. the detector 3 from FIG. 1 or the detector 13 from FIG. 2. The projection corresponds to the case of a conical radiation beam KS, which is emitted by a punctiform radiation source 2, e.g. the source 2 from FIG. 1.

The radiation beam KS impinges on the screen in the region between the points 66 and 68, which are spaced apart from one another in the vertical direction. The points 66 and 68 correspond to beams 65 and 67 of the radiation beam KS, which propagate tangentially with respect to the sphere 17. Since the illustration in FIG. 6 has been selected in such a way that the distance line AL of the radiation source 2 from the screen 13 extends in the horizontal direction and hence perpendicular to the vertical line of the extent of the screen 13, illustrated in FIG. 6, the distance between the projected points 66, 68 also equals the length of the major axis of the projected ellipse. Therefore, the center ME of the ellipse is also plotted in FIG. 6, which center is at equal distances to the points 66, 68. FIG. 6 likewise illustrates the position of the projected center MKₚ of the sphere center MK. It is possible to see that the center of the ellipse ME is distanced from this projected center MKₚ of the sphere by a length 6. This deviation in location is corrected before the comparison between the arrangement of the projected sphere centers and the arrangement of the established ellipse centers ME is carried out. In particular, by using information in respect of the geometry of the measurement arrangement (i.e. in particular the position of the radiation source, assumed to be punctiform, relative to the photocell field), it is possible initially to correct the respective ellipse center ME, established from the radiograph, in such a way that it coincides with the projected sphere center, wherein the distortion effect is still disregarded in this correction. For this correction, the assumption is therefore made that the situation corresponds precisely to the situation illustrated in FIG. 6.

In particular, the distance between the ellipse center ME and the projected sphere center MK_{P} can be calculated as follows:

δ=d/[sin α(cot²α cot²β)].

Here, d denotes the distance of the radiation source from the projected sphere center MK_{P} (i.e. the length of the center beam). α denotes the angle between the distance line AL and the center beam, β denotes the angle between the tangential beam 67 and the center beam. “cot” is the cotangent and “sin” is the sine.

If the correction is carried out for all ellipse centers, this creates a corrected first arrangement. In the following text, “first arrangement” in particular denotes the corrected first arrangement. With respect to the calibration object 16 from FIG. 2, it is now possible to carry out the compensation calculation, for example by virtue of the sum of the magnitudes of the deviations or the sum of the squared deviations between each corrected established ellipse center and the associated sphere center (in particular projected by calculation) being minimized. In a further step, the deviation remaining after this minimization (also referred to as offset) between each of the corrected established ellipse centers and the associated sphere center is established as a result of the distortion. This distortion, which can also be referred to as distortion error, is then available, for example with reference to the coordinate system of the radiograph.

In general terms, the position and orientation of the locations in the second arrangement (which corresponds to the calibration object) are matched (particularly in the best possible fashion) to the position and orientation of the locations in the first arrangement locations (wherein the actual arrangement of the structures of the calibration object and possible images in the radiograph resulting therefrom are taken into account) for the comparison between the first and the second arrangement, and remaining deviations in the locations of the second arrangement from corresponding locations in the first arrangement are identified as distortion errors.

There are six degrees of freedom of the pose (position and orientation) of the calibration object relative to the image detector and these should therefore be adapted by the adaptation and can, in particular, be determined by the compensation calculation. It is therefore preferable for the calibration object to have at least four and preferably at least 10 separate structures, for which therefore at least four or 10 points with respectively two coordinates (i.e. eight or 20 values for determining the pose) can be established in the radiograph.

FIG. 5 shows the state after executing the compensation calculation for a much simplified example with four corrected ellipse centers E1, E2, E3, E4 and four sphere centers K1, K2, K3, K4. In FIG. 5, the external edge of the image is denoted by the reference sign 59. It is possible to identify that a distance, which is the offset or the distortion error, respectively remains between the pairs of associated corrected ellipse centers and sphere centers E1, K1; E2, K2; E3, K3; E4, K4. It is possible to see that the offset can have different magnitudes and can act in different directions.

In yet a further, optional step, it is now possible to create a deviation map by virtue of, for other locations in the radiograph, which are not locations of a corrected ellipse center, determining in each case the distortion error for the other location by interpolating the distortion errors at at least three locations of corrected ellipse centers. In particular, the three locations correspond to the corners of a triangle and it is therefore possible to associate by interpolation an interpolated value (and in particular vector) of the distortion error to each location within the triangle. In particular, a portion or the whole radiograph can have a plurality of such triangles, which completely cover the portion or the radiograph such that a distortion map covering the whole area of the portion or the radiograph is obtained by interpolation. Distortion errors at locations outside of the area covered by the triangles can be established by extrapolation.

The measurement arrangements with a connected computed tomography scanner can, for example, be the X-ray computed tomography scanners METROTOM 800 or METROTOM 1500, which are supplied and distributed by Carl-Zeiss Industrielle Messtechnik GmbH, Germany.

In particular, the invention renders it possible to establish dimensions such as lengths, widths, diameters, radii of curvature of objects, produced manually or industrially, in a precise and independent fashion of the relative position and orientation of the measurement object and the detector.

FIG. 7 shows the top view of a cross 73. By way of example, if the cross is made of chromium or lead and is arranged on a plate-shaped glass ceramic carrier, the thickness of the cross 73 (measured in the direction perpendicular to the plane of the figure) is only a few hundred micrometers.

The four arms 72a, 72b, 72c, 72d of the cross 73 do not have a constant width if their extent is considered from the center MC to the free ends of the arms 72, but rather the width of the arms 72 reduces in a stepped fashion in the direction of the free end. In the illustrated exemplary embodiment, the thickness has three steps, i.e. there are three sections in each arm 72 which have a different width. The center of the projection image of such a cross can be established with great precision from a radiograph.

FIG. 8 schematically shows an arrangement of a plate-shaped carrier 71, e.g. made of glass ceramic, on the rear side of which a plurality of crosses 73 are applied, which crosses are formed by a structured material layer. By way of example, the crosses 73 in FIG. 8 can in each case be a cross as shown in FIG. 7. The crosses 73 are preferably arranged in such a way that their centers are arranged next to one another in rows and above one another in columns.

The rear side of the carrier 71 directly adjoins the surface of a flat-panel image detector 13, which, for example, is designed like the flat-panel image detector 13 illustrated in FIG. 2. When generating a radiograph of the arrangement of the crosses 73, the invasive radiation initially penetrates the side of the carrier 71 on which there are no crosses 73, penetrates the material of the carrier 71, is additionally attenuated at the positions at which the crosses are located and enters the flat-panel image detector 13 on the adjacent surface thereof.

1-15. (canceled)

16. A method of operating a measurement arrangement for a computed tomography scanner, the measurement arrangement including a radiation source of invasive radiation and a flat-panel image detector with a scintillation layer and a photocell field made of photocells for detecting radiation from the radiation source, the method which comprises:
arranging a calibration object between the radiation source and the flat-panel image detector and recording at least one radiograph of the calibration object with the flat-panel image detector; and
determining a distortion error, which was created as a result of a distortion of the flat-panel image detector, as a function of a location in the photocell field from known dimensions of the calibration object and from the at least one radiograph.

17. The method according to claim 16, which comprises recording with the flat-panel image detector a radiograph of an object to be measured and correcting the radiograph taking into account the established distortion error.

18. The method according to claim 17, wherein
recording at least one radiograph of the calibration object or another measurement object by the flat-panel image detector;
establishing individual points which respectively correspond to a structure of the calibration object or measurement object in the radiograph and only correcting the distortion error in respect of the individual points in order to thereby form an arrangement of corrected individual points.

19. The method according to claim 18, wherein the flat-panel image detector, the calibration object or measurement object and a radiation source of the invasive radiation are part of the measurement arrangement and wherein the arrangement of corrected individual points is used to determine geometry parameters of a geometric model describing a geometry of the measurement arrangement.

20. The method according to claim 16, wherein the calibration object is arranged directly adjacent the flat-panel image detector such that structures of the calibration object extend along the flat-panel image detector and, in the at least one radiograph of the calibration object created by the flat-panel image detector, appear as structure images lying next to one another and/or partly overlapping one another.

21. The method according to claim 16, wherein the calibration object has a multiplicity of separate structures, a size of the separate structures and a position of the separate structures relative to one another is known, and the step of determining the distortion error comprises using the size and relative position of the separate structures.

22. The method according to claim 21, which comprises using structure images, which were created by the separate structures in the at least one radiograph, to establish at least one location in each case in the radiograph such that a first arrangement of the established locations is obtained, and comparing the first arrangement to a second arrangement of locations which correspond to the established locations, said second arrangement corresponding to the calibration object, and establishing the distortion error from deviations of the two arrangements as a function of the location in the photocell field and/or in the radiograph.

23. The method according to claim 22, wherein, for the purposes of comparing the arrangements, the position and orientation of the locations in the second arrangement are matched to the position and orientation of the locations in the first arrangement in order to take account of different possible relative positions and orientations of the calibration object and the flat-panel image detector and remaining deviations of the locations in the first arrangement from corresponding locations in the second arrangement are identified as distortion errors.

24. A measurement arrangement for a computed tomography scanner, comprising:
a radiation source of invasive radiation and a flat-panel image detector with a scintillation layer and a photocell field made of photocells for detecting radiation from the radiation source;
an error establishment apparatus, connected to said flat-panel image detector and configured to establish a distortion error from at least one radiograph of a calibration object disposed between said radiation source and said flat-panel image detector and from known dimensions of the calibration object, the distortion error having been created as a result of a distortion of the flat-panel image detector, and wherein the distortion error is established as a function of the location in the photocell field.

25. The measurement arrangement according to claim 24, which further comprises an error correction apparatus connected to said error establishment apparatus and configured to correct a radiograph recorded of an object to be measured, taking into account the distortion error established by the error establishment apparatus.

26. The measurement arrangement according to claim 24, which further comprises the calibration object, the calibration object being arranged directly adjacent said flat-panel image detector such that structures of the calibration object extend along said flat-panel image detector and, in the at least one radiograph of the calibration object created by said flat-panel image detector, appear as structure images lying next to one another and/or partly overlapping one another.

27. The measurement arrangement according to claim 24, which further comprises the calibration object, the calibration object having a multiplicity of separate structures, the size of which and the position of which relative to one another is known, and wherein the size and relative position is used during the establishment of the distortion error.

28. The measurement arrangement according to claim 27, wherein said error establishment apparatus is configured to establish at least one location in each case in the radiograph from structure images created by the separate structures in the at least one radiograph such that a first arrangement of the established locations is obtained, to compare the first arrangement to a second arrangement of locations which correspond to the established locations, said second arrangement corresponding to the calibration object, and to establish the distortion error from deviations of the two arrangements as a function of the location in the photocell field.

29. The measurement arrangement according to claim 28, wherein the error establishment apparatus is configured, for the purposes of comparing the two arrangements, to match the position and orientation of the locations in the second arrangement to the position and orientation of the locations in the first arrangement in order to take account of different possible relative positions and orientations of the calibration object and said flat-panel image detector and to identify remaining deviations of the locations in the first arrangement from corresponding locations in the second arrangement as distortion errors.

30. The measurement arrangement according to claim 24, which further comprises a tactile coordinate measurement instrument configured to touch the calibration object and to determine a size and a position of structures of the calibration object therefrom and to provide the resulting information for establishing the distortion error.
